(19) United States
(12) Patent Application Publication
(10) Pub. No.: US 2014/0252878 A1
(43) Pub. Date: Sep. 11, 2014

(54) OVER-LOAD PROTECTION OF RADIO RECEIVERS

(71) Applicants: Joni Jantunen, Helsinki (FI); Frank Borngräber, Weissenhorn (DE); Martti Voutilainen, Espoo (FI); Jari-Jukka Kaaja, Jarvenpaa (FI); Olli Luukkonen, Helsinki (FI)

(72) Inventors: Joni Jantunen, Helsinki (FI); Frank Borngräber, Weissenhorn (DE); Martti Voutilainen, Espoo (FI); Jari-Jukka Kaaja, Jarvenpaa (FI); Olli Luukkonen, Helsinki (FI)

(73) Assignee: Nokia Corporation, Espoo (FI)

(21) Appl. No.: 14/358,286

(22) PCT Filed: Nov. 25, 2011
(86) PCT No.: PCT/FI2011/051040

§ 371 Date: May 15, 2014

(51) Int. Cl. H01F 38/14; H02H 7/20

(52) U.S. Cl. CPC H01F 38/14; H02H 7/20
USPC 307/104

(57) ABSTRACT

A radio-powered apparatus (100) is protected from overloading in strong electromagnetic fields. The apparatus uses a resonant circuitry (120) to receive antenna signals at resonance frequency of the resonant circuitry and to obtain power from the received antenna signals. For restricting energy intake of the resonant circuitry, the resonant circuitry is detuned to operate with a smaller efficiency using an adaptive element in the resonant circuitry.

### TECHNICAL FIELD

The present application generally relates to over-load protection of radio receivers. In particular, though not exclusively, the present application relates to over-load protection of near field communication devices.

### BACKGROUND

Near-field communication (NFC) enables use of radio receivers such as passive devices that receive their operation power over air with an antenna. Such passive devices produce their operating power from electric signals the antenna produces. For ensuring sufficient energy under normal use cases, the passive devices have a resonant circuitry known as matching and tuning network connected to the antenna. The resonant circuitries greatly increase electric power available to the passive device and thus enable their normal use with very low power radio signals. NFC devices are also exploiting the fact that omni-directional electromagnetic field weakens inversely proportional to a third power of propagation distance. Resonant matching and tuning circuitries enable producing power two orders of magnitude higher than those received by an antenna without resonance. By further operating within short range of e.g. few millimeters or few centimeters, the NFC devices can work with economically low power levels.

### SUMMARY

Various aspects of examples of the invention are set out in the claims.

According to a first example aspect of the present invention, there is provided an apparatus, comprising:

a resonant circuitry configured to receive from an antenna signals at resonance frequency of the resonant circuitry and to obtain power from the received signals;

the resonant circuitry comprising an adaptive element configured to restrict energy intake by the resonant circuitry by detuning the resonant circuitry to operate with a smaller efficiency.

According to a second example aspect of the present invention, there is provided a method comprising:

using a resonant circuitry, receiving from an antenna signals at resonance frequency of the resonant circuitry and obtaining power from the received signals;

restricting energy intake of the resonant circuitry by detuning the resonant circuitry to operate with a smaller efficiency using an adaptive element in the resonant circuitry.

According to a third example aspect of the present invention, there is provided an apparatus, comprising:

a processor configured to

using a resonant circuitry, receive from an antenna signals at resonance frequency of the resonant circuitry and obtain power from the received signals; and

restrict energy intake of the resonant circuitry by detuning the resonant circuitry to operate with a smaller efficiency using an adaptive element in the resonant circuitry.

According to a fourth example aspect of the present invention, there is provided an apparatus, comprising:

at least one processor; and

at least one memory including computer program code

the at least one memory and the computer program code configured to, with the at least one processor, cause the apparatus to perform at least the following:

using a resonant circuitry, receive from an antenna signals at resonance frequency of the resonant circuitry and obtain power from the received signals; and

restrict energy intake of the resonant circuitry by detuning the resonant circuitry to operate with a smaller efficiency using an adaptive element in the resonant circuitry.

According to a fifth example aspect of the present invention, there is provided a computer program, comprising:

code for, using a resonant circuitry, receiving from an antenna signals at resonance frequency of the resonant circuitry and obtaining power from the received signals; and

code for restricting energy intake of the resonant circuitry by detuning the resonant circuitry to operate with a smaller efficiency using an adaptive element in the resonant circuitry;

when the computer program is run on a processor.

The computer program may be a computer program product comprising a non-transitory computer-readable medium bearing computer program code embodied therein for use with a computer.

According to a sixth example aspect of the present invention, there is provided an apparatus, comprising:

a resonant circuitry means for receiving from an antenna signals at resonance frequency of the resonant circuitry and for obtaining power from the received signals;

the resonant circuitry means comprising adapting means for restricting energy intake by the resonant circuitry by detuning the resonant circuitry to operate with a smaller efficiency.

Any foregoing memory medium may comprise a digital data storage such as a data disc or diskette, optical storage, magnetic storage, holographic storage, opto-magnetic storage, phase-change memory, resistive random access memory, magnetic random access memory, solid-electrolyte memory, ferroelectric random access memory, organic memory or polymer memory. The memory medium may be formed into a device without other substantial functions than storing memory or it may be formed as part of a device with other functions, including but not limited to a memory of a computer, a chip set, and a sub assembly of an electronic device.

### BRIEF DESCRIPTION OF THE DRAWINGS

For a more complete understanding of example embodiments of the present invention, reference is now made to the following descriptions taken in connection with the accompanying drawings in which:

FIG. 1 shows an architectural overview of an apparatus of an example embodiment of the invention;

FIG. 2 shows a block diagram of an adjustable capacitor according to an example embodiment;

FIG. 3 shows a block diagram illustrating some details of a dual-mode mode communication capable apparatus according to an example embodiment;

FIG. 4 shows a flow chart of operation in a controlling element according to an example embodiment;

FIG. 5 shows an example of a coil that is controllable by switches; and

FIG. 6 shows a block diagram of an apparatus 600 according to an example embodiment for operating as the controlling device.

### DETAILED DESCRIPTION OF THE DRAWINGS

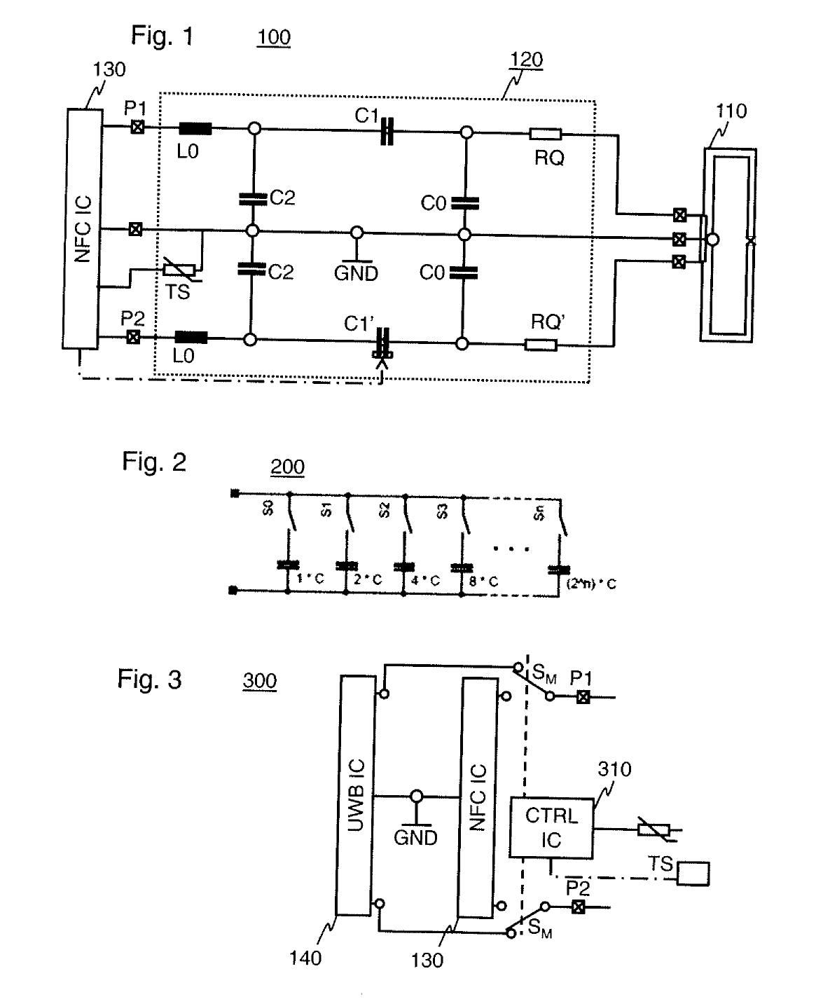

An example embodiment of the present invention and its potential advantages are understood by referring to FIGS. 1 through 4 of the drawings.

FIG. 1 shows an architectural overview of an apparatus 100 of an example embodiment of the invention. The apparatus comprises an antenna 110 connected to a matching/tuning network 120 also referred to as a resonant circuitry for amplifying power gained by the antenna 110. The antenna 110 of FIG. 1 is drawn to comprise one loop for receiving antenna signals and another loop for operating as a ground plane. In another example embodiment, the antenna comprises, for receiving antenna signals, a coil having more than one loop.

The resonant circuitry 120 comprises at least one coil and at least one capacitor. The apparatus 100 further comprises a near field communication (NFC) circuitry 130, in FIG. 1 drawn as an NFC integrated circuitry (IC), as an example of a proximity radio circuitry. The NFC IC 130 comprises two radio receiving and/or transmission ports P1, P2. The resonant circuitry 120 of FIG. 1 comprises in two parallel branches, one for each of the ports P1, P2, and in series between each port and respective antenna connection, a serial quality resistor RQ, RQ′, serial capacitor C1, C1′ and a serial coil L0. The resonant circuitry 120 comprises two further capacitors C0, C2 connected to ground from a point between the serial resistor RQ, RQ′ and from a point between the serial capacitor C1, C1′ and the coil L0. The quality resistors affect on the quality factor Q of the resonant circuitry 120 such that the larger the resistance, the smaller the Q factor. The serial capacitors C1, C1′, further capacitors C0, C2 and coils L0 together define the tuning of the resonant circuitry 120. Notice that the quality factor Q applies only to the resonant frequency band of the resonant circuitry 120.

In one example embodiment, the antenna 110 is comprised by the resonant circuitry 120. In another example embodiment, the antenna 110 is a component that is not comprised by the resonant circuitry 120. If the antenna 110 is not comprised the resonant circuitry 120, the resonant circuitry comprises an interface for functionally connecting the antenna 110 with the resonant circuitry 120. The interface comprises, for example, contact pads, ends of connectors, connection points on circuit board or nodes via which the antenna 110 can be connected with resonant circuitry. The connection itself can be direct connection made e.g. by soldering, clamping or screwing electrically conductive parts together, or through one or more components that enable the resonant circuitry 120 function with the antenna 110 as described in this document.

It is useful to understand that in operation, the resonant circuitry 120 is configured to be loaded during tens or hundreds of radio signal cycles when the resonant circuitry's resonance frequency coincides with the frequency of the radio signals. Thus, the resonant circuitry can produce increased power from the antenna signals at the resonance frequency even though energy or power available for the antenna remained unchanged.

In one example embodiment, the quality factor of the resonant circuitry 120 is 30 at the resonant frequencies of the first and second branches. Now, let us assume that the apparatus 100 is brought close to a wireless charging station or other device or station that causes a strong radio signals to be received with the antenna 110 at the resonant frequency of the resonant circuitry 120. Consequently, the resonant circuitry 120 increases the power obtained by the antenna with an amount relative to the quality factor Q and overloads the NFC IC 130. In order to avoid the overloading, the apparatus of FIG. 1 is provided with automatic load control that comprises an adapting element in the resonant circuitry 120 configured to detune the resonant circuitry 120 by changing its resonant frequency and/or reducing its Q factor, a sensing element TS and a controlling element that based on the sensing element TS controls the adapting element. The detuning of the resonant circuitry reduces the efficiency of the resonant circuitry in obtaining power from the received antenna signals and providing obtained power to other components such as the NFC IC 130. The load control is based in one example embodiment on temperature feedback from the sensing element TS.

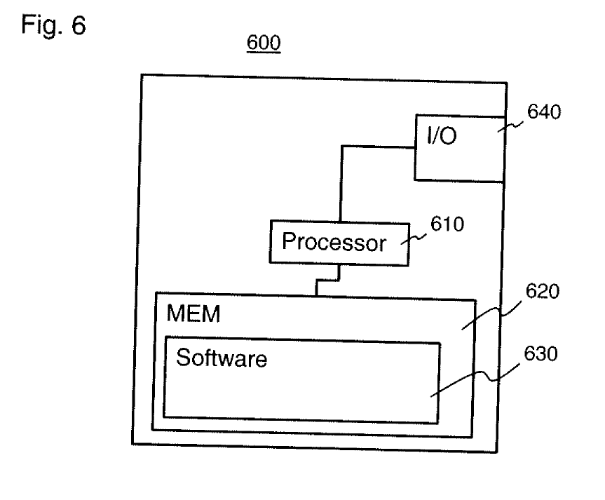

The adapting element is in an example embodiment any one or more of the resistors, capacitors and coils in the resonant circuitry 120. For instance, a positive temperature coefficient (PTC) resistor can be used as the serial resistor RQ′ the resistance of which increases as a function of the temperature of the resistor. In this case, the serial resistor (e.g. reference sign RQ′ and/or RQ) operates as the sensing element TS, as the controlling element and also as the adapting element. Thus, increasing temperature leads to reducing Q-factor and thus detuning of the resonant circuitry. As another example, one or more of the capacitors can be temperature dependent. In one example embodiment, a capacitor or coil is formed of one or more individual capacitor or coil elements with one or more controllable switches so that the total capacitance or inductance can be controlled to change the resonant frequency of the resonant circuitry 120. The controlling element in this embodiment is, for instance, the NFC IC 130 as shown in FIG. 1. In another example embodiment, there is another digital circuitry or an analog circuitry configured to control the controllable switches. Such an analog circuitry can be formed, for example, of a reverse biased diode. The controllable switches can be formed using typical analog components such as transistors and resistors. One example embodiment of the controlling element is shown in FIG. 6 and described with reference to FIG. 6.

In an example embodiment, the center frequency of the resonant circuitry is changed by 2 MHz to 4 MHz.

FIG. 1 shows the sensing element TS as an additional element using a drawing symbol of a thermistor. The sensing element TS is also drawn with two connections one of which is grounded. In practice, the sensing element can be a component at least one continually measureable property of which depends on temperature of any one or more components in the resonant circuitry 120. For fast reaction to large currents in the resonant circuitry 120, the sensing element TS can be in thermal connection with one or more components in the resonant circuitry. The sensing element TS is, in one example embodiment, a piezoelectric element. Every material experiences thermal expansion. The piezoelectric element can be fixed to, for instance, a rigid substrate such as a circuit board to which the resonant circuitry 120 is attached. In piezoelectric materials mechanical stress makes electric charges to accumulate in different parts of the material depending on the direction of the mechanical stress and this evokes a voltage difference over the material. It should be understood that the sensing element TS as an additional element is unnecessary e.g. if one of the resonant circuitry's components is inherently dependent on the power that passes through the component or on its temperature and thus restrains maximum energy pickup by the resonant circuitry. For example, one or both of the serial resistors RQ, RQ′ can be a thermistor.

FIG. 2 shows an example of an adjustable capacitor 200 for use as a serial capacitor (C1 or C1′) and/or as a further capacitor (C2). With the array shown in FIG. 1, it is possible to set any capacitance with the increment of one basic capacitance c from c to (2ⁿ⁺¹−1)·c, where n is the number of capacitors in parallel connection and each but one capacitor has a double capacitance in comparison to one other capacitor, i.e. the capacitances of the capacitors conform to a series of powers of two. The adjustable capacitor 200 is also usable for impedance matching. In practice, the adjustable capacitor 200 can be implemented by using a digitally tunable capacitor.

In one example embodiment, one or more of the coils are made controllable such that there are intermediate nodes with which parts of the coil can be bypassed using switches S0, S1 and S2 and thus the number of loops in the coil changes, see FIG. 5 for an example of an adjustable coil 500 that can be used e.g. as the serial coil L0 or as an antenna coil. If the number of loops between different nodes increases in a series of powers of two, similar adjustability as shown in FIG. 2 for the capacitors can be provided. In another example embodiment, one or more coils are made controllable by a core of an easily saturable material with current biased winding which controls the permeability of the core. In one example, current flowing through the coil flows through the core's bias winding and the bias winding is so dimensioned that at normal currents, the bias winding does not substantially alter the inductance of the coil but when the current exceeds a threshold value, the inductance of the coil changes.

In yet another example embodiment, a voltage dependent capacitor is used in the resonant circuitry 120 for load control.

In one example embodiment, the controllable switches shown in FIG. 2 are each controlled to open in a series of increasing voltages such that the more the voltage increases, the larger a change is incurred to the total capacitance of the adjustable capacitor 200. This controlling is made, in one example embodiment with analog components. In another example embodiment, one or more but not all of the switches are initially closed and further switches are closed to detune the resonant circuitry 120 for load control.

In case of using a PTC resistor for detuning the resonant circuitry 120, the resistor itself forms a sensing element. Numerical control is provided in one example embodiment based on detected voltage, in which case one sensing element is used as a voltage or temperature sensor for guiding the numerical control. In one example embodiment, the sensing element is selected from a group consisting of a thermistor, resistance temperature detector (RTD), a thermocouple, fiber optic temperature sensor, and silicon temperature sensor.

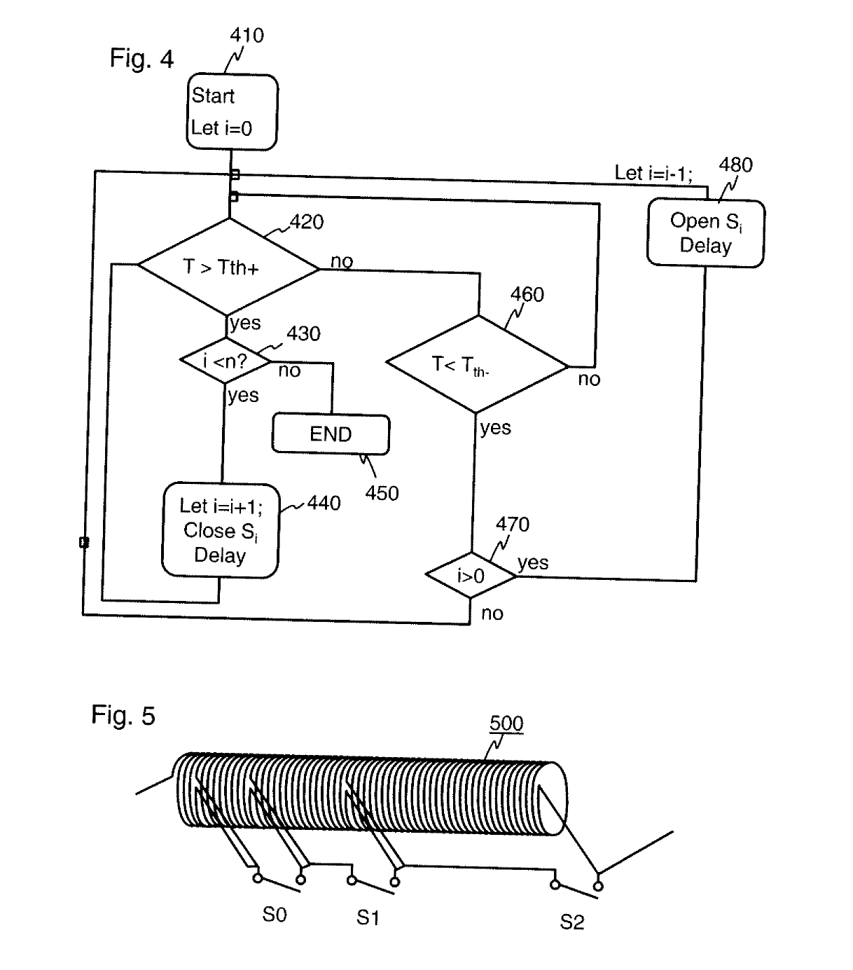

FIG. 3 shows block diagram illustrating some details of a dual-mode communication capable apparatus 300. The apparatus 300 of FIG. 3 is otherwise corresponding to the apparatus 100 of FIG. 1, but there are now two integrated circuits, i.e. the NFC IC 130 shown in FIG. 1 and an ultra-wide band IC 140 representing respective two different communication interfaces. Moreover, instead of the NFC IC 130, a separate part operating as a controlling element 310 is drawn. FIG. 3 further presents two controllable switches S_{M} controlled by the controlling element 310 for selecting the mode of the apparatus 300. The controlling element 310 controls at least the communication mode. In addition, the controlling element 310 may also control externally controlled components (such as C1′) if present in the resonant circuitry 120.

The controlling element 310 need not be a separate or dedicated element. In an example embodiment, the controlling element 310 is integrated with another circuitry, such as the UWB IC.

In a first state, the apparatus 300 of FIG. 3 operates as a near field communication device using a first frequency band and using a first radio signal power range. In a second state, the apparatus 300 operates as a high-speed communication device that communicates on a second frequency band and obtains energy on the first frequency band in a second radio signal power range that is higher than the first radio signal power range. For the high data rate operation (e.g. with UWB), higher power is needed that in the first state and thus the Q-factor is configured higher than in the first state. Moreover, when the first frequency band is not needed for data communications (second frequency band is used for that purpose), relatively high Q-factors such as 100 and more can be used in the resonant circuitry 120. For communication, such high Q-factors may hinder conveying information modulated in the signals passing through the resonant circuitry 120. In the first state, the apparatus 300 operates e.g. as a normal NFC device and the Q-factor is relatively low, e.g. 30.

The first frequency band may be in the order of tens of MHz, e.g. 13.56 MHz. The second frequency band may be in the order of gigahertz, e.g. 8 GHz. Correspondingly, the data rates of communication in the first and second state may be e.g. 400 kbps and up to 1 Gbps, respectively. The power received by the antenna 110 may be in a few milliwatts when used for NFC, for instance. On the other hand, the power received when close to a charging station may be 1000 times higher. Moreover, relatively high power levels may be required for wireless transmission and especially storing data into a nonvolatile memory like Flash memory, Phase Change memory (PCM) or ferroelectric memory (Fe-RAM). These power levels can be significantly higher than RFID tags can tolerate, such as 1 nJ/bit=1 W at 1 Gbps writing rate. By increasing transmitted power the ordinary radio frequency identity device (RFID) or NFC receiving systems would be damaged. Thus, to avoid accidental damaging of NFC tags, charging stations and other sources of strong electromagnetic fields, even if very local, the sources and NFC devices should be equipped with complex systems for detecting the presence of exposed sensitive devices and for limiting transmission powers if such sensitive devices are too near.

Without in any way limiting the scope, interpretation, or application of the claims appearing below, a technical effect of one or more of the example embodiments disclosed herein is that by detuning a tuning/matching circuitry, power intake can be limited without incurring substantial heat generation in a voltage limiting circuitry, which may be particularly problematic in miniaturized RFID or NFC tags. Another technical effect of one or more of the example embodiments disclosed herein is that the resonant circuitry may be configured to have a high sensitive or large Q-factor and thus the range of the apparatus can be greater without exposing the apparatus to overloading at short range and strong signals. Another technical effect of one or more of the example embodiments disclosed herein is that sources of strong electromagnetic signals need not be specifically equipped to avoid overloading proximate sensitive devices such as RFID or NFC tags.

FIG. 4 shows a flow chart of operation in a controlling element or controller according to an example embodiment. First, a counter i is set 410 to zero. Then, it is compared 420 whether the temperature at a given point of the resonant circuitry 120 or over the entire resonant circuitry 120 (e.g. using a piezoelectric element) exceeds a first threshold value Tₜₕ₊. If yes, it is checked 430 if the counter i is still below the maximum n i.e. if there are still switches to be closed. If no, the process ends 450. Otherwise, the process advances to step 440 where the counter i is incremented by one and next switch Sᵢ (see FIG. 2) is closed. The controller also waits for first delay to let the effect of the change become discernible. The first delay is, in one example embodiment, fixed to a given value, for example 5 to 100 ms. In another example embodiment the first delay is dependent on the value of the counter i value. For example, the first delay can be defined as T_{d}=(100−i·90/n) ms). After step 440, the process returns to step 420.

If in step 420 the temperature T was not greater or equal to a first threshold value, it is checked in step 460 if the temperature T is smaller than a second threshold value Tₜₕ₋. In an example embodiment, the second threshold value Tₜₕ₋ is smaller than the first threshold value Tₜₕ₊ by a given amount to produce a desired hysteresis. If T<Tₜₕ₋, it is checked 470 if the counter i is still greater than zero i.e. whether there are still some switches to be opened. If no, the process resumes to step 420 or ends, depending on implementation. If yes, the process advances to step 480 in which switch Sᵢ is opened and it is waited for a second delay for the effect of the opening of the switch Sᵢ. Then the process again resumes to step 420.

In FIG. 4, a simplification was made such that on incrementing values of the counter i, a corresponding switch was closed and on decrementing values of the counter i, a corresponding switch was opened. However, it is understood that the capacitance can be also changed with finer granularity by simultaneously opening and closing switches to form various combinations of the separately switchable capacitances. The embodiment presented in FIG. 4 is yet fast and progressively effective by switching off ever greater portion of the capacitance of the system 200. Whether switches are simply opened one by one or closed one by one as the temperature increases or decreases depends on the desired design and also on the associated delays and on the speed of the sensing element. In one embodiment, the apparatus 100, 300 is configured to make a maximum possible detuning in a period of 0.1 to 1 s, or in 0.4 or 0.5 s.

FIG. 6 shows a block diagram of an apparatus 600 according to an example embodiment for operating as a controlling device such as one described in connection with FIG. 1. The general structure of the apparatus 600 comprises an input/output port 640, a processor 610 coupled to the input/output port 640, and a memory 620 coupled to the processor 610. The apparatus further comprises software 630 stored in the memory 620 and operable to be loaded into and executed in the processor 610. The software 630 may comprise one or more software modules and can be in the form of a computer program product.

The input/output port 640 comprises an analog to digital converter configured to receive incoming analogue signals and to form corresponding digital signals for digital processing. The input/output port 640 further comprises a voltage output e.g. for controlling the switches S0, S1 . . . shown in FIG. 2 and/or 5.

The processor 610 may be, e.g., a central processing unit (CPU), a microprocessor, a digital signal processor (DSP), a graphics processing unit, an application specific integrated circuit (ASIC), a field programmable gate array, a microcontroller or a combination of such elements.

The memory 620 may be for example a volatile or a non-volatile memory, such as a read-only memory (ROM), a programmable read-only memory (PROM), erasable programmable read-only memory (EPROM), a random-access memory (RAM), a flash memory, a data disk, an optical storage, a magnetic storage, a smart card, or the like. The apparatus 600 may comprise a plurality of memories. The memory 620 may be constructed as a part of the apparatus 600 or it may be inserted into a slot, port, or the like of the apparatus 600 by a user. The memory 620 may serve the sole purpose of storing data, or it may be constructed as a part of an apparatus serving other purposes, such as processing data.

Embodiments of the present invention may be implemented in software, hardware, application logic or a combination of software, hardware and application logic. The software, application logic and/or hardware may reside on a dedicated controller such as the controller element 310 or on an element with other functions such as the NFC IC 130, on the UWB IC 140. If desired, the software, application logic and/or hardware may be divided in two or more different elements or units. In an example embodiment, the application logic, software or an instruction set is maintained on any one of various conventional computer-readable media. In the context of this document, a “computer-readable medium” may be any media or means that can contain, store, communicate, propagate or transport the instructions for use by or in connection with an instruction execution system, apparatus, or device, such as a computer. A computer-readable medium may comprise a computer-readable storage medium that may be any media or means that can contain or store the instructions for use by or in connection with an instruction execution system, apparatus, or device, such as a computer.

If desired, the different functions discussed herein may be performed in a different order and/or concurrently with each other. Furthermore, if desired, one or more of the above-described functions may be optional or may be combined.

Although various aspects of the invention are set out in the independent claims, other aspects of the invention comprise other combinations of features from the described embodiments and/or the dependent claims with the features of the independent claims, and not solely the combinations explicitly set out in the claims.

While the above describes example embodiments of the invention, these descriptions should not be viewed in a limiting sense. Rather, there are several variations and modifications which may be made without departing from the scope of the present invention as defined in the appended claims.

1-40. (canceled)

41. An apparatus, comprising:
a resonant circuitry configured to receive from an antenna signals at resonance frequency of the resonant circuitry and to obtain power from the received signals;
the resonant circuitry comprising an adaptive element configured to restrict energy intake by the resonant circuitry by detuning the resonant circuitry to operate with a smaller efficiency.

42. The apparatus of claim 41, wherein the adaptive element is configured to change capacitance in the resonant circuitry.

43. The apparatus of claim 40, wherein the adaptive element is configured to change the capacitance by selectively switching one or more capacitors to operate in the resonant circuitry.

44. The apparatus of claim 41, wherein the adaptive element is configured to change inductance of an inductor in the resonant circuitry or in the antenna.

45. The apparatus of claim 44, wherein the antenna comprises a coil having two or more loops.

46. The apparatus of claim 40, wherein the adaptive element is configured to change the inductance by selectively switching one or more groups of loops to operate in the inductor, each group comprising at least one loop.

47. The apparatus of claim 41, wherein the resonant circuitry comprises the antenna.

48. The apparatus of claim 41, wherein the resonant circuitry does not comprise the antenna and the resonant circuitry comprises an interface configured to enable functionally connecting of the antenna with the resonant circuitry.

49. The apparatus of claim 41, wherein the adaptive element is configured to restrict energy intake by the resonant circuitry by detuning the resonant circuitry based on temperature feedback to operate with a smaller efficiency.

50. The apparatus of claim 41, wherein the adaptive element is configured to change resistance in the resonant circuitry.

51. The apparatus of claim 41, wherein the adaptive element is configured to reduce quality factor of the resonant circuitry by the change of resistance in the resonant circuitry.

52. The apparatus of claim 41, wherein the apparatus comprises a first communication interface configured to communicate at a first frequency band and a second communication interface configured to take operation energy on the first frequency band and to communicate at a second frequency band different from the first frequency band.

53. A method, comprising:
using a resonant circuitry, receiving from an antenna signals at resonance frequency of the resonant circuitry and obtaining power from the received signals; and
restricting energy intake of the resonant circuitry by detuning the resonant circuitry based on temperature feedback to operate with a smaller efficiency using an adaptive element in the resonant circuitry.

54. The method of claim 53, wherein the detuning of the resonant circuitry is carried out by changing capacitance in the resonant circuitry.

55. The method of claim 54, wherein the capacitance is changed by selectively switching one or more capacitors to operate in the resonant circuitry.

56. The method of claim 53, wherein the detuning of the resonant circuitry is carried out by changing inductance of an inductor in the resonant circuitry or in the antenna.

57. The method of claim 56, wherein the changing of the inductance is carried out by selectively switching one or more groups of loops to operate in the inductor, each group comprising at least one loop.

58. The method of claim 53, wherein the resonant circuitry comprises the antenna.

59. The method of claim 53 wherein the resonant circuitry does not comprise the antenna and the resonant circuitry comprises an interface configured to enable functionally connecting of the antenna with the resonant circuitry.

60. The method of claim 53 wherein the restricting energy intake of the resonant circuitry by detuning the resonant circuitry is based on temperature feedback.
